(19) United States
(12) Patent Application Publication
(10) Pub. No.: US 2018/0240119 A1
(43) Pub. Date: Aug. 23, 2018

(54) APPARATUS, COMPUTER PROGRAM AND METHOD

(71) Applicant: IPCO 2012 LIMITED, London (GB)

(72) Inventors: Syed Asim Ali SHAH, London (GB); Jeremy Stephens, London (GB); Michael Dewar, London (GB); Marc Corbalan, London (GB); David Divitt, London (GB)

(73) Assignee: IPCO 2012 LIMITED, London (GB)

(21) Appl. No.: 15/649,732

(22) Filed: Jul. 14, 2017

(30) Foreign Application Priority Data
Feb. 17, 2017 (GB) 1702619.6

(51) Int. Cl. G06Q 20/40; G06Q 20/10; G06Q 40/02

(52) U.S. Cl. CPC G06Q 20/4016; G06Q 40/02; G06Q 20/10

(57) ABSTRACT

An apparatus for identifying an end node bank account in a network of bank accounts for funds from a fraudulent transaction, comprising processing circuitry configured to: identify a node account into which funds from the fraudulent transaction are paid; determine the number of account relationships associated with the node account; and identify the node account as an end node bank account when the number of account relationships is above a threshold value.

### BACKGROUND

### Field of the Disclosure

The present technique relates to an apparatus, computer program and method.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present technique.

Banking fraud and scamming is an increasing problem. In a typical fraud or scam, a perpetrator of the fraud will illegally obtain funds from a victim's bank account. This may be via a “phishing” or “malware” attack where access to the victim's bank facilities is obtained. For example a perpetrator of the fraud or scam may access a victim's account or deceptively obtain funds via the victim transferring funds into the perpetrator's bank account.

After the funds have been transferred from the victim's account, the perpetrator will transfer funds through numerous other bank accounts. These other bank accounts may be legitimate accounts which have also been compromised, bank accounts set up using illegally obtained documents (such as a stolen or fake passport), or may be rented from a 3^{rd} party to be used for illicit purposes.

The speed at which the funds are transferred is usually very high. Typically, a transfer between multiple banks' accounts may be completed within a few minutes.

This transfer of funds occurs for two reasons. The first reason is to make tracing the funds very complicated. This is because investigation is done manually using the limited view of data from each bank on a bank by bank basis. Therefore, it is difficult to trace the movements of funds originating from the initial fraudulent transaction across the banking network. This is especially the case where the funds obtained from the victim are typically mixed with other funds in each bank account (some legitimate funds and some illegitimate funds). This makes tracing the funds incredibly difficult.

The second reason is to disperse the money in the original transaction. This allows the perpetrator to, for example, withdraw small amounts of money as cash from e.g. an Automated Teller Machine (ATM) or to buy lower value products in a shop without arousing suspicion.

In some instances, some money from a fraudulent transaction may pass through tens of bank accounts in a few hours. This number of accounts and the speed at which the funds transfer makes tracing the funds using conventional mechanisms impossible.

It is an aim of the disclosure to address these issues.

### SUMMARY

According to embodiments of the disclosure, there is provided an apparatus for identifying an end node bank account in a network of bank accounts for funds from a fraudulent transaction, comprising processing circuitry configured to: identify a node account into which funds from the fraudulent transaction are paid; determine the number of account relationships associated with the node account; and identify the node account as an end node bank account when the number of account relationships is above a threshold value.

According to embodiments of the disclosure, there is provided an apparatus for identifying an end node bank account in a network of bank accounts for funds from a fraudulent transaction, comprising processing circuitry configured to: identify a node account into which funds from the fraudulent transaction are paid at a first time; determine that funds have been transferred from the node account at a second time; and identify the node account as an end node bank account when the time difference between the first time and the second time is above a threshold.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows an apparatus according to embodiments of the present disclosure;

FIGS. 2A and 2B show a schematic diagram of a fraudulent transaction;

FIG. 3 shows a flow chart according to embodiments; and

FIG. 4 shows a flow chart explaining the checking in a single account according to embodiments of the disclosure.

### DESCRIPTION OF THE EMBODIMENTS

Referring now to the drawings, wherein like reference numerals designate identical or corresponding parts throughout the several views.

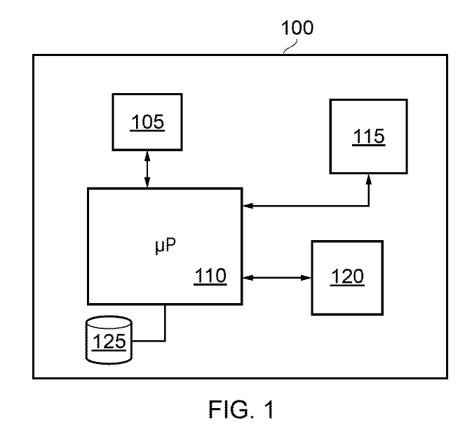

Referring to FIG. 1, an apparatus 100 according to embodiments of the disclosure is shown. Typically, an apparatus 100 according to embodiments of the disclosure is a computer device such as a personal computer or a terminal connected to a server. Indeed, in embodiments, the apparatus may also be a server. The apparatus 100 is controlled using a microprocessor or other processing circuitry 110.

The processing circuitry 110 may be a microprocessor carrying out computer instructions or may be an Application Specific Integrated Circuit. The computer instructions are stored on storage medium 125 which maybe a magnetically readable medium, optically readable medium or solid state type circuitry. The storage medium 125 may be integrated into the apparatus 100 or may be separate to the apparatus 100 and connected thereto using either a wired or wireless connection. The computer instructions may be embodied as computer software that contains computer readable code which, when loaded onto the processor circuitry 110, configures the processor circuitry 110 to perform a method according to embodiments of the disclosure.

Additionally connected to the processor circuitry 110, is a user input 105. The user input maybe a touch screen or maybe a mouse or stylist type input device. The user input 105 may also be a keyboard or any combination of these devices.

A network connection 115 is also coupled to the processor circuitry 110. The network connection 115 may be a connection to a Local Area Network or a Wide Area Network such as the Internet or a Virtual Private Network or the like. The network connection 115 may be connected to banking infrastructure allowing the processor circuitry 110 to communicate with other banking institutions to obtain relevant data or provide relevant data to the institutions. The network connection 115 may therefore be behind a firewall or some other form of network security.

Additionally coupled to the processing circuitry 110, is a display device 120. The display device, although shown integrated into the apparatus 100, may additionally be separate to the apparatus 100 and maybe a monitor or some kind of device allowing the user to visualise the operation of the system. In addition, the display device 120 may be a printer or some other device allowing relevant information generated by the apparatus 100 to be viewed by the user or by a third party.

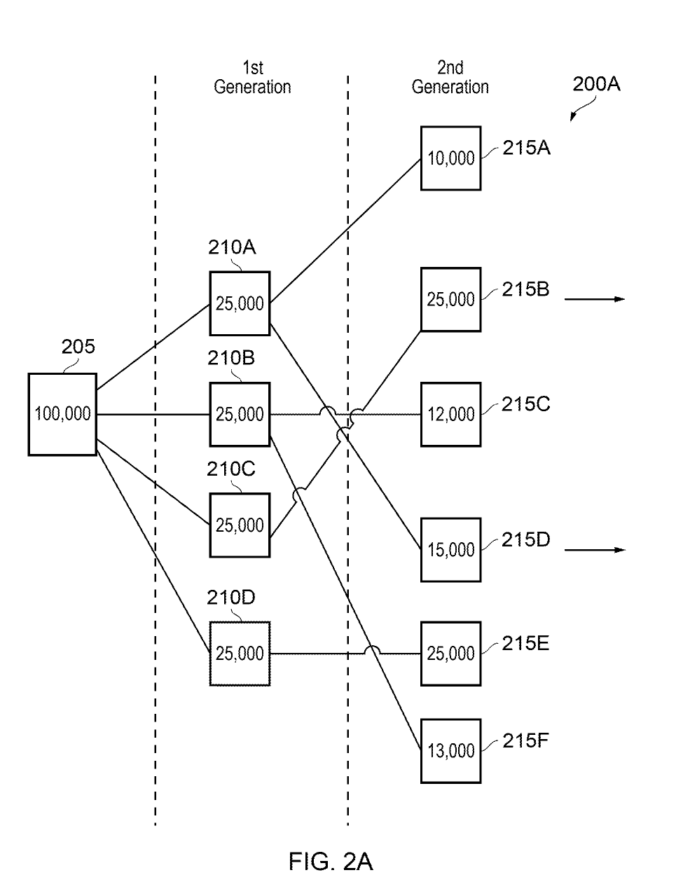

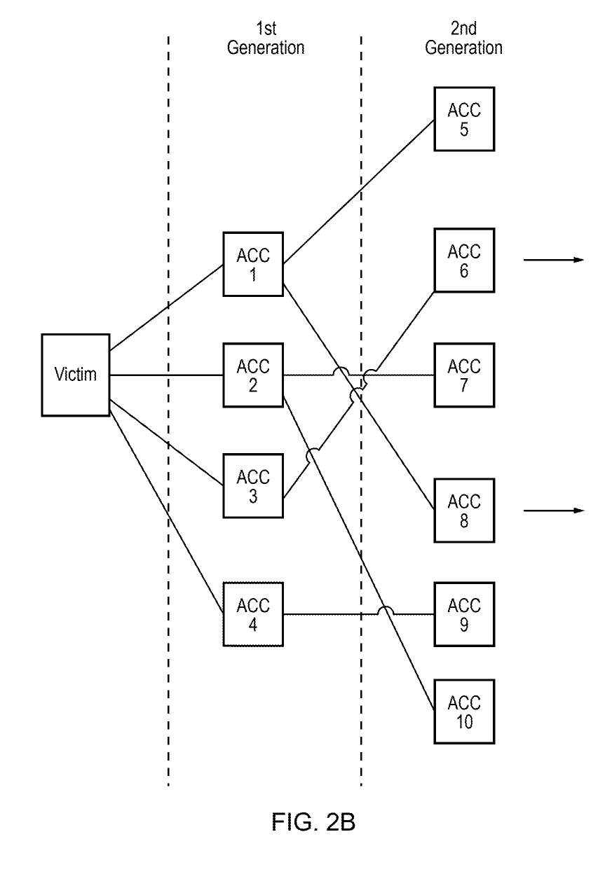

Referring to FIGS. 2A-2B, a schematic diagram showing a fraudulent transaction is shown.

The embodiments of the present disclosure aim to trace the flow of funds subsequent to a fraudulent transaction. In particular, one aim of the present disclosure is to trace the funds in a very efficient and quick manner. This is important given the number of bank accounts through which the fraudulently obtained money flows and the speed at which the money flows the various accounts in a fraudster's network as well as the high number of non-fraud accounts that funds may flow to. This enables the possible recovery of the money and importantly the closure of bank accounts associated with fraudulent activity in a timely fashion.

In FIG. 2A, a chart showing the dispersal of money from a fraudulent activity is shown. In particular, a victim 205 has £100,000 stolen from their account using fraudulent means. For example, a fraudster may use one of a myriad of techniques in order to comprise the security of the account. The fraudster may contact the victim reporting to be a bank employee and to fraudulently obtain secret information which then allows the fraudster to illegally transfer £100,000 from the victim's account.

Typically, the fraudster will utilise a transaction which allows money to be transferred between various bank accounts very quickly and within a matter of seconds or minutes.

In the example of FIG. 2A, the fraudster transfers the £100,000 of the victim's money as four transactions each of £25,000. In FIG. 2A, this is illustrated with £25,000 being allocated to account 1 210A, account 2 210B, account 3 210C, and account 4 210D. These accounts may be in the same banking organisation or may be different banking organisations. Typically, this fraudulently obtained money may be mixed with other money located in the respective bank accounts. The other money in the respective bank accounts may be legitimate money or other fraudulent money. These bank accounts are the first generation of bank accounts associated with the fraudulent activity.

Within a few minutes of the money reaching the bank accounts in the first generation of accounts, the fraudsters then transfer the money to different bank accounts which are termed second generation bank accounts. In the example of FIG. 2A, the fraudsters transfer £10,000 from account 1 210A to account 5 215A and £15,000 to account 8 215D. Similarly, the fraudsters transfer £12,000 from account 2 210B to account 7 215C and £13,000 to account 10 215F. The fraudsters transfer £25,000 from account 3 210C transfers to account 6 215B. Finally, the fraudsters transfer £25,000 from account 4 210D to account 9 215E.

As with the first generation bank accounts, each of the second generation bank accounts 215A-215F may be with the same or different banking organisations.

The process of transferring the money away then continues for possibly many generations of bank accounts. The purpose of the distribution of the money to various bank accounts is so that at a final step, the terminating bank accounts usually have smaller quantities of cash which may be extracted using an Automatic Teller Machine (ATM) or may be used to purchase goods from a shop without arousing suspicion or extracted from the terminating bank account in some way. Nevertheless, given the speed at which the money can be distributed between fraudulent accounts, the initial £100,000 stolen from victim 205 may be extracted and used within a few hours of the initial fraudulent transaction.

It is important to note that this does not mean that the first generation bank accounts or the second generation bank accounts have no money remaining after the transfer. Typically, the fraudster will use bank accounts having some other funds (either legitimate or illegitimate). This makes it very difficult to identify which of the money passed to the second generation bank account is associated with the initial fraudulent activity. It is therefore important to identify the bank accounts associated with fraudulent activity very quickly so that those accounts can be closed to frustrate the fraudster from performing similar fraudulent transactions.

This is especially the case since the transfer from the first generation bank accounts to the second generation bank accounts is usually carried out very quickly and within minutes of the initial fraudulent activity 205.

Tracing this stolen money is very difficult using known techniques. This is because banks will typically only see money entering one account and leaving the same account a short time later; there is no indication to the bank that these transactions are linked. Additionally, as banking regulations are very tightly controlled, it is difficult to obtain information pertaining to an individual's bank account. This means tracking the money after the fraudulent activity has taken place can be very difficult. This is especially the case if the bank accounts in the fraudulent network are located in different countries.

FIG. 2B shows the network of accounts associated with the fraudulent transaction in FIG. 2A.

From FIG. 2B, it will be apparent to the skilled person in the art, that the victim bank account is a root node of a network. Each bank account within the network is therefore a node of the network. The transaction transferring the money is therefore an edge of the network. This means that the skilled person in the art may consider the network as a graph and, therefore, may implement graph theory in analysing the network.

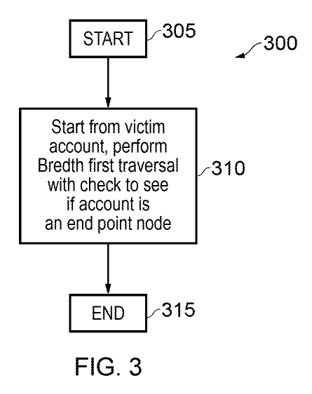

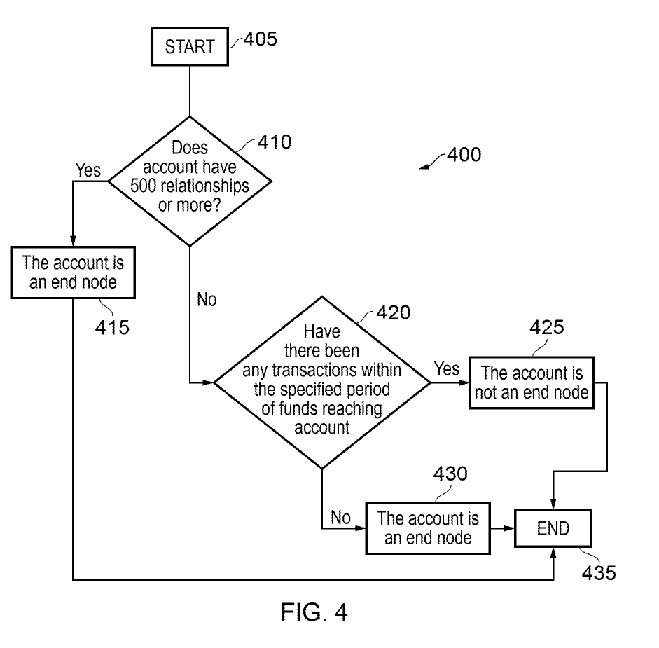

FIG. 3 shows a flowchart explaining embodiments of the disclosure used to trace this fraudulent activity very quickly. The flowchart 300 starts at the start block 305. The process moves to step 310. In step 310, a Breadth-First traversal of the network is carried out. In this type of traversal, the root node is processed first, then all of its children are processed next and then all of the children's children are processed next. In this traversal, in embodiments, a check is conducted at each node (bank account). This check determines whether the node is an end-point node. In other words, the check determines if the node is part of the fraudulent dispersal. The check of one account, according to embodiments, will be described with reference FIG. 4.

A brief description will follow set in the context of the embodiments of FIG. 2B.

The initiating fraudulent transaction from the victim account (the root node) to “Acc 1”, “Acc 2”, “Acc 3” and “Acc 4” (nodes) of FIG. 2B is tracked. At each of these nodes, the check of FIG. 4 is carried out as will be explained later to determine if any of the children nodes (Acc 1 to Acc 4) is an end point node of the network.

Any children nodes which are end point nodes do not form part of the fraudulent dispersal and no further tracing of transactions from that end-point node will be carried out.

On the other hand, for any of the first generation nodes which are not end point nodes, the transactions from each of the non-end point nodes are traced to a second generation of nodes (i.e. the children of those first generation nodes). These transactions may be time limited so that only transactions occurring within a period of time from the funds arriving in the account are traced. Examples of this time period include any period between 24 hours and 148 hours. As explained later, this period is statistically significant. The check of FIG. 4 is then applied to each of these second generation nodes to see which, if any, of these second generation nodes are also part of the fraudulent dispersal.

In FIG. 2B, therefore, as all of the first generation nodes (Acc 1 to Acc 4) are not end points, the check of FIG. 4 is applied to each of the second generation nodes. In other words, the check of FIG. 4 is applied to each of Acc 5, Acc 6, Acc 7, Acc 8, Acc 9 and Acc 10.

Turning to FIG. 4, embodiments of the disclosure are disclosed in the flow chart 400 which is a check applied to each node. This process is implemented, in embodiments, as computer readable code stored on storage medium 125. The process is carried out on processor circuitry 110.

The process starts at step 405. The process moves to step 410 where a first check is performed to determine whether the account under test (the node) has a predetermined number of account relationships. In some embodiments, the predetermined number is 500 or more account relationships. In this instance, an account relationship is set up between two accounts when a payer transfers money to a payee for the first time within the period of time of data stored in the process. This is an advantageous check because most large organisations, such as utility companies or local authority institutions (which are legitimate and so will not transfer fraudulent funds out of the account) have 500 or more account relationships. Of course, although in embodiments, 500 or more account relationships is chosen as the predetermined number, the disclosure is not so limited. The number may be less or more than this. However, it is noted here that the inventors have identified this number as being statistically significant.

Accordingly, in step 410, if the account has 500 or more account relationships, the yes path is followed to step 415 where it is determined that the account is an end node. The checking process then ends at step 435.

Alternatively, if the account has less than 500 account relationships, the no path is followed to step 420.

By performing this check, therefore, it is possible to quickly eliminate large organisations (which will not propagate the fraudulent money) from the remainder of check process. This reduces computational burden on the apparatus of FIG. 1 and accelerates the checking of the node.

Returning to step 420 of FIG. 4, a second decision is made. Specifically, it is determined whether there have been any transactions out of the account within a specified period of the incoming transaction to the node. For example, not only may a transaction in this instance include transferring money to another bank account, but a transaction may include a withdrawal of cash from an ATM, or a debit card purchase or the like.

In embodiments, the specified period is between 24 and 148 hours. This period is statistically significant because this identifies the typically rapid diffusion of fraudulent transactions whilst ignoring the natural flow of non-fraudulent transactions such as utility bill payments or the like. Of course other periods of time are envisaged such as 12 hours as well as various periods within this advantageous range of 24 to 148 hours.

In the event that there have been outgoing transactions from the account within the specified period of time, the yes path is followed to step 425 and the account is determined to not be an end-point node. Alternatively, if there has not been outgoing transactions from the account within the period of time, the no path is followed to step 430 and the account is determined to be an end-point node.

After step 425 or 430 has concluded, the flow chart moves to step 435 where the process ends.

It should be noted here that although the foregoing describes the check includes identifying the number of account relationships followed by determining that other outgoing transactions took place a predetermined time after the inbound transaction, the disclosure is not so limited.

Specifically, each of these checks may be performed on their own to assist in tracing the fraudulent accounts. This would still achieve the effect of quickly identifying the fraudulent accounts very quickly.

Alternatively, or additionally, the ordering of the two-step check of FIG. 4 may be performed in any order.

The checking process of embodiments described in FIG. 4 is particularly advantageous in the field of fraud detection because the account(s) used in fraudulent transactions can be traced quickly. This allows financial institutions to be notified of accounts which are used in fraudulent and scamming activity so that money can be stopped leaving those accounts and ultimately those accounts can be closed.

In addition, the checking process of embodiments of FIG. 4 identifies large organisations which are not used to propagate fraudulent funds. By quickly identifying these organisations and determining that these are the end node, they are quickly removed from the tracing path. This reduces the number of nodes to be traced which reduces the time and computational resource required in tracing the money.

Once the accounts have been identified, this information is passed to the banks involved. It is important to pass this information to the banks quickly. This is because, as noted above, the banks will only ever see money being transferred into an account and money being transferred from an account. The link to fraudulent activity would only ever be identified to the bank much later on (if ever) using known techniques. However, by using embodiments of the disclosure, fraudulent activity is identified to the bank much more quickly. This information will be provided to the bank using the network connection 115.

Numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Embodiments of the present technique can generally described by the following numbered clauses:

1. An apparatus for identifying an end node bank account in a network of bank accounts for funds from a fraudulent transaction, comprising processing circuitry configured to: identify a node account into which funds from the fraudulent transaction are paid; determine the number of account relationships associated with the node account; and identify the node account as an end node bank account when the number of account relationships is above a threshold value.
2. An apparatus according to clause 1, wherein the threshold value is 500.
3. An apparatus according to clause 1, wherein the funds are received at the node at a first time, and the processing circuitry is configured to: determine that funds have been transferred from the node account at a second time; and identify the node account as an end node bank account when the time difference between the first time and second time is above a threshold.
4. An apparatus for identifying an end node bank account in a network of bank accounts for funds from a fraudulent transaction, comprising processing circuitry configured to: identify a node account into which funds from the fraudulent transaction are paid at a first time; determine that funds have been transferred from the node account at a second time; and identify the node account as an end node bank account when the time difference between the first time and the second time is above a threshold.
5. An apparatus according to clause 4, wherein the threshold is between 24 and 148 hours.
6. An apparatus according to clause 4, wherein the processing circuitry is configured to determine the number of account relationships associated with the node account; and identify the node account as an end node bank account when the number of account relationships is above a threshold value.
7. An apparatus according to clause 1 or 4, comprising a network connection configured to provide the identified node account to a bank.
8. A method for identifying an end node bank account in a network of bank accounts for funds from a fraudulent transaction, comprising identifying a node account into which funds from the fraudulent transaction are paid; determining the number of account relationships associated with the node account; and identifying the node account as an end node bank account when the number of account relationships is above a threshold value.
9. A method according to clause 8, wherein the threshold value is 500.
10. A method according to clause 8, wherein the funds are received at the node at a first time, and the method further comprises: determining that funds have been transferred from the node account at a second time; and identifying the node account as an end node bank account when the time difference between the first time and second time is above a threshold.
11. A method for identifying an end node bank account in a network of bank accounts for funds from a fraudulent transaction, comprising: identifying a node account into which funds from the fraudulent transaction are paid at a first time; determining that funds have been transferred from the node account at a second time; and identifying the node account as an end node bank account when the time difference between the first time and the second time is above a threshold.
12. A method according to clause 11, wherein the threshold is between 24 and 148 hours.
13. A method according to clause 11, comprising determining the number of account relationships associated with the node account; and identifying the node account as an end node bank account when the number of account relationships is above a threshold value.
14. A method according to clause 8, comprising providing the identified node to a bank over a network connection.
15. A computer program product comprising computer readable code, which when loaded onto a computer configures the computer to perform a method according to either one of clauses 8 or 11.

1: An apparatus for identifying an end node bank account in a network of bank accounts for funds from a fraudulent transaction, the apparatus comprising:
processing circuitry configured to
identify a node account into which funds from the fraudulent transaction are paid,
determine the number of account relationships associated with the node account, and
identify the node account as an end node bank account when the number of account relationships is above a threshold value.

2: The apparatus according to claim 1, wherein the threshold value is 500.

3: The apparatus according to claim 1, wherein the funds are received at the node at a first time, and wherein the processing circuitry is further configured to
determine that funds have been transferred from the node account at a second time, and
identify the node account as an end node bank account when the time difference between the first time and second time is above a threshold.

4: An apparatus for identifying an end node bank account in a network of bank accounts for funds from a fraudulent transaction, the apparatus comprising:
processing circuitry configured to
identify a node account into which funds from the fraudulent transaction are paid at a first time,
determine that funds have been transferred from the node account at a second time, and
identify the node account as an end node bank account when the time difference between the first time and the second time is above a threshold.

5: The apparatus according to claim 4, wherein the threshold is between 24 and 148 hours.

6: The apparatus according to claim 4, wherein the processing circuitry is configured to
determine the number of account relationships associated with the node account, and
identify the node account as an end node bank account when the number of account relationships is above a threshold value.

7: The apparatus according to claim 1, further comprising a network connection configured to provide the identified node account to a bank.

8: A method for identifying an end node bank account in a network of bank accounts for funds from a fraudulent transaction, the method comprising:
identifying a node account into which funds from the fraudulent transaction are paid;
determining the number of account relationships associated with the node account; and
identifying the node account as an end node bank account when the number of account relationships is above a threshold value.

9: The method according to claim 8, wherein the threshold value is 500.

10: The method according to claim 8, wherein the funds are received at the node at a first time, and wherein the method further comprises
determining that funds have been transferred from the node account at a second time; and
identifying the node account as an end node bank account when the time difference between the first time and second time is above a threshold.

11: A method for identifying an end node bank account in a network of bank accounts for funds from a fraudulent transaction, the method comprising:
identifying a node account into which funds from the fraudulent transaction are paid at a first time;
determining that funds have been transferred from the node account at a second time; and
identifying the node account as an end node bank account when the time difference between the first time and the second time is above a threshold.

12: The method according to claim 11, wherein the threshold is between 24 and 148 hours.

13: The method according to claim 11, further comprising:
determining the number of account relationships associated with the node account; and
identifying the node account as an end node bank account when the number of account relationships is above a threshold value.

14: The method according to claim 8, further comprising:
providing the identified node to a bank over a network connection.

15: A non-transitory computer-readable medium including instructions, that when executed by at least one processor, cause the processor to perform a method according to claim 8.
